(19) United States
(12) Patent Application Publication
(10) Pub. No.: US 2009/0298686 A1
(43) Pub. Date: Dec. 3, 2009

(54) Metallic carrier for catalysts or particle separators and the use of this carrier

(75) Inventor: Matthias Mangold, Eschenlohe (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: OBERLAND MANGOLD GMBH, Eschenlohe (DE)

(21) Appl. No.: 12/473,742

(22) Filed: May 28, 2009

(30) Foreign Application Priority Data
May 29, 2008 (DE) 102008025761.3

(51) Int. Cl. B01J 21/02

(52) U.S. Cl. 502/439

(57) ABSTRACT

A metallic carrier for a catalytic converter or particle separator and the use of a metallic carrier for exhaust gas cleaning of internal combustion engines, especially diesel engines, is provided. The metallic carrier comprises an aluminum alloy having an aluminum content of 75 to 99.5 percent by mass. The metallic carrier helps achieve an advantageous reduction in the mass of the carrier and thermal capacity, as a result of which the light-off temperature is reached more rapidly. The reduction of mass and thermal capacity is not at the expense of a reduction in the catalytic carrier surface.

### CROSS-REFERENCE TO RELATED APPLICATIONS

This application claims priority to German Patent Application No. 102008025761.3, filed on May 29, 2008, the disclosure of which is incorporated herein by reference in its entirety.

### FIELD OF THE INVENTION

The invention relates to a metallic carrier for a catalytic converter or particle separator and the use of a metallic carrier for exhaust gas cleaning of internal combustion engines.

### BACKGROUND OF THE INVENTION

Catalytic converters or particle separators are known for reducing the exhaust gas components CO, HC, NOx and particulates, comprising metallic carriers made of high-grade steel with mostly axially extending channels. As is known, such carriers are wound up or coiled in a spiral or S-shaped manner into a circular cylinder from one or several layers of thin, mostly partly embossed metal foils with a foil thickness of 0.05 mm for example and are inserted into a carrier jacket which also consists of high-grade steel and are optionally welded together. The metallic carriers are coated with a wash-coat which is used on the one hand for enlarging the surface and on the other hand for receiving noble-metal components.

Measures within the engine such as the optimization of the combustion parameters, cooled exhaust gas recirculation, etc. lead to a decrease in the exhaust gas temperatures of diesel engines, which as a result of the process have exhaust gas temperatures anyway which are lower than those of spark-ignited engines. Especially under partial load as in city traffic for example or in areas of the exhaust line which are disposed remote from the engine, the operating temperatures are not reached sufficiently fast through thermal inertia of the components in the exhaust line such as catalytic converters for example, which temperatures are mandatory for reaching an effective catalytic reaction of the pollutants to be reduced. This leads to difficulties in converting the pollutants especially during cold starting and dynamic load variations.

That is why the research and development of modern metallic carriers are aimed at achieving a reduction in the thermal capacity of the carrier, so that the so-called “light-off” temperature of the catalytic converter is achieved even more rapidly.

One known metal carrier includes perforations. The thermal capacity is reduced with the help of these perforations in order to reach the “light-off” temperature more rapidly. The disadvantageous aspect in this case is the loss of the catalytic surface by the perforations.

Another known carrier includes expanded metal. In this case too, the reduction of the thermal capacity, which leads to reaching the “light-off” temperature more rapidly, is linked to the loss of the reactive carrier surface.

### SUMMARY OF THE INVENTION

Embodiments of the present invention advantageously provide a metallic carrier, with the help of which the “light-off” temperature is reached even more rapidly, with the loss of the support surface being minimized.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DETAILED DESCRIPTION

Embodiments of the present invention provide a metallic carrier comprising an aluminum alloy that has an aluminum content of 75 to 99.5 percent by mass, especially between 80 and 99.5 percent by mass.

Table 1 illustrates the advantages of the inventive carrier in comparison with carriers from the state of the art.

For the purpose of comparison, a total of three different metallic carriers from the state of the art are compared with a special embodiment of the carrier with an aluminum content of 99.5 percent by mass. The “standard” carrier is a high-grade steel carrier without any perforations; the carrier with the “holes” comprises bore holes which are offset regularly by 60° and have a diameter of 8 mm and a division of 11 mm in both foils. The expanded-metal carrier comprises meshes which are distributed regularly with a mesh size of 0.5×0.6 mm and a web width of 0.18 mm. Properties concerning the carrier geometry are stated in the lines a through f in Table 1 and obviously coincide in all four carriers for the purpose of comparison.

TABLE 1

| | | | |
|---|---|---|---|
| | | | Carrier |
| “Standard” | Carrier with | Expanded- | according to |
| carrier | “holes” | metal carrier | invention |

Carrier data

| | | | |
|---|---|---|---|
| a | Carrier diameter | [mm] | 150 |
| b | Carrier length | [mm] | 150 |
| c | Outside diameter of carrier | [mm] | 153 |
| | jacket (with s = 1.5 mm) | | |
| d | Length of carrier jacket | [mm] | 160 |
| e | Thickness of foil layer | [mm] | 0.05 |
| f | Cell density | [cpsi] | 400 |

Material data

| | | | | | | |
|---|---|---|---|---|---|---|
| g | Material | | High-grade | High-grade | High-grade | Aluminium 99.5 |
| | | | steel 1.4767 | steel 1.4767 | steel | |
| h | Density of material | [kg/m\hat{ }3] | 7200 | 7200 | 7200 | 2700 |
| i | Thermal conductivity | [W/(m*K)] | 13 | 13 | 13 | 221 |
| j | Specific thermal capacity | [J/(kg*K)] | 490 | 490 | 490 | 900 |

Masses

| | | | | | | |
|---|---|---|---|---|---|---|
| k | Mass of carrier | [kg] | 2.05 | 1.27 | 1.53 | 0.76 |
| l | Mass of carrier jacket | [kg] | 0.90 | 0.90 | 0.90 | 0.31 |
| m | Total mass (carrier + | [kg] | 2.95 | 2.17 | 2.43 | 1.07 |
| | carrier jacket) | | | | | |
| n | Reduction of total mass | [%] | | 26.44 | 17.63 | 63.73 |
| | over “standard” mass | | | | | |

Surfaces

| | | | | | | |
|---|---|---|---|---|---|---|
| o | Perforated surface | m\hat{ }2 | 0 | 4.30 | 2.40 | 0 |
| p | Carrier surface | m\hat{ }2 | 11.30 | 7.00 | 8.90 | 11.30 |
| q | Loss of surface area in | [%] | | 38.05 | 21.24 | 0 |
| | comparison with | | | | | |
| | “standard” carrier | | | | | |

Thermal capacities

| | | | | | | |
|---|---|---|---|---|---|---|
| r | Thermal capacity of | [J/K] | 1445.50 | 1063.30 | 1190.70 | 963.00 |
| | carrier + carrier jacket | | | | | |
| s | Reduction of thermal | [%] | | 26.44 | 17.63 | 33.38 |
| | capacity over “standard” | | | | | |
| | carrier | | | | | |

Material-specific properties are stated in lines g through j. The considerable advantage of aluminum over high-grade steel is especially clear in the density of the material. The density of aluminum is only approx. one-third of the density of the high-grade steel with the material number 1.4767 which is used in most carrier applications. Different percentages of alloys obviously cause a small change in the density and thus the mass. However, the measurable changes in the density are negligibly small as long as the main components of the alloys, i.e. aluminum in the aluminum alloy or iron in the alloyed high-grade steel, remain the same.

The thermal conductivity of the material aluminum is higher by a factor of 17 than the thermal conductivity of the high-grade steel 1.4767 (line i, Table 1). This leads to the consequence that the formation of so-called “hot spots”, i.e. places of local overheating, is considerably lower in the inventive carrier than in conventional high-grade steel carriers. Low thermal conductivity, i.e. adverse thermal conduction within the material, can lead to damage to the material due to local over-heating and furthermore extends the heating-up duration of the carrier, which is disadvantageous especially in the case of cold starts and dynamic load changes which will gain increasingly more importance for the emission certification of driving cycles.

The specific thermal capacity is a material property which in the case of aluminum is larger by a factor of 1.8 in comparison with high-grade steel 1.4767, as is shown in line j of Table 1. When determining the thermal capacity of carrier and carrier jacket however, the masses of the carrier and the carrier jacket are considered. It follows from this that the inventive metallic carrier with the carrier jacket, despite the higher specific thermal capacity of aluminum, has a distinctly lower thermal capacity in comparison with the “standard” carrier because the clearly lower mass of the inventive carrier with the carrier jacket more than only “compensates” the higher specific thermal capacity of the aluminum. The thermal capacity of the compared inventive aluminum carrier, which does not comprise any perforations, lies even beneath that of the perforated carriers (line r, Table 1).

It can be stated in summary that the inventive metallic carrier offers clear advantages over the compared carriers of the state of the art concerning reduction of mass (line n, Table 1) and the reduction of the thermal capacity (line s, Table 1), without reducing the catalytic carrier surface (line q, Table 1).

Moreover, the inventive metallic carrier is characterized by outstanding resistance to corrosion. It is known that aluminum forms an oxide layer made of Al₂O₃ on the surface in an oxygen-rich environment, as a result of which the inventive carrier is provided with extreme resistance to corrosion. This Al₂O₃ layer, which is also formed in conventional metallic carriers with aluminum as an alloying element, with the content of aluminum being relatively low with up to approx. 8 percent by mass, grows continuously during operation by utilizing the alloying element of aluminum. After a long period of operation, this growth process leads to a depletion of aluminum in the carrier by out-diffusion and thus to the destruction of the carrier by so-called “breakaway” corrosion. Since the embodiments of the metallic carrier include aluminum as the main component with a content of 75 to 99.5 percent by mass, a secure protection from corrosion is always ensured by the protective Al₂O₃ layer. Moreover, the better Al₂O₃ layer leads to an improved adherence of the wash-coat in the metallic carrier in accordance with the invention.

A further advantage of the inventive carrier over the perforated carriers, in addition to the reduction of the mass and the thermal capacity and in addition to the increase in the catalytic surface, is that production costs are also saved because the additional costs in the production due to perforations by means of drilling or stretching can be avoided.

Aluminium alloys are exceptionally well suited for rolling, so that extremely thin foil thicknesses of even under 0.05 mm, e.g. 0.03 mm or even 0.01 mm, can be reached. Furthermore, aluminum alloys can be formed and machined exceptionally well, so that the inventive carrier can be perforated in a special embodiment in the known manner in order to further reduce mass and thermal capacity and in order to further provide the same with the known deflection elements according to a further embodiment in order to increase the dwell time and surface contact of the exhaust-gas components in the catalytic converter or particle separator.

“Pure” aluminum with an aluminum content of 100% is not available technically because there are always certain shares of impurities or additives such as iron or silicon whose content can differ from batch to batch. For this reason, “pure” aluminum is usually understood to have an aluminum content of 99.5%.

In a preferred further development, the inventive carrier comprises one or several alloying elements from the group which consists of titanium (Ti), iron (Fe), silicon (Si), nickel (Ni), magnesium (Mg), manganese (Mn), chromium (Cr), copper (Cu) and zinc (Zn). The content of all alloying elements in the metallic carrier is between 0.4 and 25 percent by mass, preferably between 0.5 and 25 percent by mass, especially preferably between 0.5 and 16 percent by mass. By adding the alloy elements in a purposeful manner, properties such as strength, hardness, resistance to corrosion, processability, etc. are influenced in a positive way.

In a preferred further development, the inventive carrier comprises a titan content of between 0.4 and 25 percent by mass, preferably 0.5 and 8 percent by mass.

In an advantageous embodiment, the inventive metallic carrier has a magnesium content of between 0 and 6 percent by mass, especially between 0 and 3 percent by mass. Magnesium leads to an increase in the strength of the aluminum alloy.

According to an advantageous embodiment, the inventive metallic carrier has a silicon content of between 0 and 10 percent by mass, especially preferably between 0 and 3 percent by mass.

In an advantageous embodiment, the inventive metallic carrier has a chromium content of between 0 and 23 percent by mass, especially between 0 and 5 percent by mass.

In a further advantageous embodiment, the inventive metallic carrier has a nickel content of between 0.5 and 25 percent by mass, preferably between 0.5 and 8 percent by mass.

In a further preferred embodiment, the inventive carrier comprises a carrier jacket which also includes an aluminum alloy with an aluminum content of 75 to 99.5 percent by mass. Preferably, the carrier jacket includes the same aluminum alloy with the same contents of alloying elements as the carrier itself. An even higher reduction in mass can be achieved in this way, which especially in the case of large-volume catalytic converters and particle separators for commercial vehicles for example is especially advantageous. In view of increasingly more stringent exhaust gas standards for carbon dioxides too (CO2), the reduction in mass achieved by the present invention also leads to an advantageous reduction in consumption and thus a reduction of CO2.

According to a preferred embodiment, the inventive carrier jacket includes conventional high-grade steel. In this way, the advantage of rapidly reaching the “light-off” by the carrier made of an aluminum alloy can be combined with the advantage of favorable heat storage capacity of the high-grade steel jacket.

In a preferred embodiment, the inventive metallic carrier comprises a second casing which encloses the carrier jacket. The second casing is made from high-grade steel for example and is joined by clamping, riveting, soldering or welding to the carrier jacket and the connecting parts which are adjacent in the exhaust line to the carrier jacket and the second casing. It is advantageous in this respect to arrange an intermediate layer made of a foamed or glass mat between the carrier jacket and the second casing made of high-grade steel in order to compensate the different temperature expansions of the materials, which are the aluminum alloy and high-grade steel, on the one hand, and to insulate the heat in the carrier to the highest possible extent on the other hand. The second casing also provides advantages concerning noise insulation. Alternatively, it is also possible to provide an air-gap insulation between the carrier jacket and the second casing, with the carrier jacket having a connection to the second casing in only a few areas. With the help of air-gap insulation, the heat insulation is improved, so that less heat is dissipated from the catalytic converter to the ambient environment.

The connection parts according to a further preferred embodiment are arranged directly adjacent to the carrier jacket or adjacent to the second casing and are also made of an aluminum alloy with an aluminum content of 75 to 99.5 percent by mass. They are joined by means of riveting, soldering or welding with the carrier jacket or the second casing and provide the connection to the remainder of the exhaust system. A further reduction in mass can thus be achieved. The connection parts can obviously also consist of high-grade steel.

According to a preferred embodiment, both the carrier jacket with the carrier as well as the carrier per se are soldered with solder, preferably aluminum solder, especially aluminum solder with a fluxing agent. It has proven to be especially advantageous to use aluminum solder or wire having a silicon content of 1 to 20 percent by mass, especially 5 to 15 percent by mass. The soldering temperature is ideally in a range of 500 to 720° C.

In a preferred further development, the inventive carrier has a foil thickness of 0.01 to 0.2 mm, especially preferably a foil thickness of 0.03 to 0.08 mm. With the help of these thin different foil thicknesses, the cell density of the carrier can be varied, depending on the application, between 100 and 1000 cpsi (cells per square inch). The exhaust gas backpressure is lowered with increasing thickness of the foil.

As already mentioned, metallic carriers are formed from at least one or preferably two superimposed layers of foil, with the one layer of foil being smooth and the other layer of foil being embossed, so that after winding or coiling even flow channels are formed. According to an advantageous embodiment, the one smooth foil layer consists of an aluminum alloy with an aluminum content of between 75 to 99.5 percent by mass and the other embossed foil layer consists of conventional high-grade steel. It is also possible to provide a reverse combination with a smooth layer of high-grade steel and an embossed layer of an aluminum alloy with an aluminum content of between 75 to 99.5 percent by mass. In this way, the advantages of rapidly reaching the “light-off” temperature by aluminum can be combined with the advantages of favorable heat storage capability of high-grade steel into a type of hybrid catalytic converter. As a result, the existing heat can be stored advantageously by the high-grade steel foil layer in certain areas of driving cycles in which the catalytic converter or particle separators are not supplied with sufficient heat from the engine, so that the aluminum layer is kept warm longer. When the engine goes back to load operation, the advantage of quicker heat-up of the aluminum foil layer will apply, so that the “light-off” temperature is reached more rapidly.

According to a further advantageous embodiment, the inventive carrier may include hybrid foil layers which after the winding, by starting out from the central axis of the carrier, have a radial inner region consisting of an aluminum alloy with an aluminum content of 75 to 99.5 percent by mass and a radially outside area made of high-grade steel. A reverse arrangement is also possible and advantageous, which is a radial inner region made of high-grade steel and a radial outside region made of an aluminum alloy with an aluminum content of 75 to 99.5 percent by mass. In this way, the mentioned advantages of aluminum alloy can be combined with the advantages of high-grade steel.

In an advantageous embodiment of the present invention, the first and/or second foil layer of the metallic carrier has holes whose diameter lies between 0.1 and 0.5 mm, with the free cross section of the perforation being between 25 and 50%. In this way, a further reduction in weight is achieved which ensures an even quicker reaching of the “light-off” temperature.

Preferably, the first and/or second foil layer of the carrier have a microstructure for swirling the laminar gas flow in the individual cells. The conversion rate of the catalytic converter is increased by the swirling or turbulence of the exhaust gas flow.

Preferably, the inventive carrier is used as a carrier for catalytic converters or particle separators. The metallic carrier is especially suitable for use as a carrier for a primary catalytic converter, oxidation catalytic converter, hydrolysis catalytic converter, SCR catalytic converter or an ammonia blocking converter. The carrier can be used similarly well for a particle separator. Modern diesel engines, but also diesel engines that are already currently in use, have exhaust gas temperatures in the widest ranges of the exhaust line, and especially in the area of the underbody, which lie far beneath the melting temperature of pure aluminum of 660° C. The exhaust gas temperatures which are lower anyway in comparison with spark-ignited engines are reduced even further by measures such as cooled exhaust gas recirculation, so that the focus does not lie on the increase in the temperature stability of the metallic carrier, but rather on the rapid reaching of the “light-off” temperature. With the help of the metallic carrier it is managed convincingly to effectively reduce the exhaust gas component without damaging the carrier material. Preferred operating temperatures of the metallic carrier lie in a range of 150 to 600° C. As a result, the metallic carrier is not only highly suitable for applications in new vehicles, but also for retrofitting existing exhaust gas treatment systems both for diesel as well as spark-ignition engines.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A metallic carrier for a catalytic converter or particle separator for exhaust gas cleaning of an internal combustion engine, comprising an aluminum alloy having an aluminum content of 75 to 99.5 percent by mass.

2. A metallic carrier according to claim 1, wherein the metallic carrier comprises at least one alloying element from a group consisting of elements Ti, Fe, Si, Ni, Mg, Mn, Cr, Cu and Zn, with the content of the alloy elements in the metallic carrier being between 0.4 and 25 percent by mass, preferably between 0.5 and 25 percent by mass, especially preferably between 0.5 and 16 percent by mass.

3. A metallic carrier according to claim 1, wherein the metallic carrier has a titanium content of between 0.4 and 25 percent by mass, preferably between 0.5 and 8 percent by mass.

4. A metallic carrier according to claim 1, wherein the metallic carrier has a magnesium content of between 0 and 6 percent by mass.

5. A metallic carrier according to claim 1, wherein the metallic carrier has a silicon content of between 0 and 10 percent by mass.

6. A metallic carrier according to claim 1, wherein the metallic carrier has a chromium content of between 0 and 23 percent by mass.

7. A metallic carrier according to claim 1, wherein the metallic carrier has a nickel content of between 0.5 and 25 percent by mass, preferably between 0.5 and 8 percent by mass.

8. A metallic carrier according to claim 1, further comprising a carrier jacket made of high-grade steel or said aluminum alloy.

9. A metallic carrier according to claim 8, wherein a second casing is arranged around the carrier jacket, with an intermediate layer of foamed or glass mat arranged between the carrier jacket and the second casing.

10. A metallic carrier according to claim 1, further comprising connection parts for installation of the carrier in an exhaust line, the connection parts made of an aluminum alloy with an aluminum content of 75 to 99.5 percent by mass.

11. A metallic carrier according to claim 1, further comprising at least one and preferably two superimposed wound layers of foil with a thickness of 0.01 to 0.2 mm, the first layer of foil being smooth and the second layer of foil being embossed.

12. A metallic carrier according to claim 11, wherein the first and/or the second layer of foil comprise holes having a diameter between 0.1 and 0.5 mm, with the free cross section of the perforation being between 25 and 50%.

13. A metallic carrier according to claim 11, wherein the first and/or second layer of foil comprise a microstructure for swirling the laminar gas flow.

14. A metallic carrier according to claim 11, wherein the first foil layer is made of an aluminum alloy with an aluminum content of 75 to 99.5 percent by mass and the second layer of foil is made of high-grade steel, or vice-versa.

15. A metallic carrier according to claim 8, further comprising a solder, preferably an aluminum solder, especially preferably an aluminum solder with a fluxing agent, for soldering the carrier in itself and/or for soldering the carrier with the carrier jacket, the solder having an Si content of 1 to 20 percent by mass.

16. A metallic carrier according to claim 15, wherein the aluminum solder has a soldering temperature of 500 to 720° C. during the soldering of the carrier in itself and/or in the soldering of the carrier with the carrier jacket.

17. The use of a metallic carrier according to claim 1, wherein the metallic carrier is used as a carrier for a preliminary, oxidation, hydrolysis, SCR, blocking catalytic converter or for a particle separator, with the occurring operating temperatures lying in a range of 150 to 600° C.
